(19) United States
(12) Patent Application Publication
(10) Pub. No.: US 2026/0338470 A1
(43) Pub. Date: Oct. 29, 2026

(54) THIN-PLATE DRYING DEVICE WITH SLURRY APPLIED

(71) Applicant: G.I.Tech Co., Ltd., Asan-si (KR)

(72) Inventors: IN YOUNG LEE, Gwangmyeong-si (KR); KANG HYUNG KIM, Asan-si (KR)

(73) Assignee: G.I.Tech Co., Ltd., Asan-si (KR)

(21) Appl. No.: 19/187,965

(22) Filed: Apr. 23, 2025

(51) Int. Cl. F26B 21/35; F26B 3/04; F26B 21/33; F26B 21/37

(52) U.S. Cl. CPC F26B 21/35; F26B 3/04; F26B 21/33; F26B 21/37

(57) ABSTRACT

A thin-plate drying device for coating a thin plate with slurry includes a housing; a thin-plate support provided in an inner space of the housing and having an upper surface on which a thin plate including a slurry coating layer formed on a surface of the thin plate is mounted; and a heating unit provided below the thin-plate support and configured to heat a drying fluid in the inner space of the housing, wherein a temperature of a first drying fluid supplied to the thin plate by the heating unit is maintained to be relatively higher than a temperature of a second drying fluid supplied to the slurry coating layer.

### BACKGROUND

### Technical Field

The present disclosure relates to a thin-plate drying device for coating a thin plate with slurry, and more specifically, to a thin-plate drying device that prevents a slurry coating layer from being defective by supplying a drying fluid to the slurry coating layer formed on a surface of a thin plate and the thin plate and drying the slurry coating layer.

### Background Art

In general, in secondary batteries, solar cells, fuel cells, capacitors, flexible semiconductors, displays, and so on, electrodes, dielectric films, semiconductors, insulators, circuits, and so on are formed by coating thin plates made of metal, polymer, ceramic, glass, or so on with slurry in addition to a deposition method.

There are various coating layer coating methods, such as a bar coating method, a doctor blade coating method, a knife method, a slot die coating method, a gravure method, an immersion method, an extrusion method, a curtain method, a reverse roll method, a direct roll method, an air curtain method, and a brush coating method. A coating method of the present disclosure uses the coating methods described above regardless of the presence or absence of additional processes, such as silkscreen for partial circuit formation.

A coating thickness varies depending on materials and usage conditions, but is not limited in particular as long as a thickness of 0.1 to 500 μm may be uniformly obtained on a thin plate after coating.

Also, the present disclosure includes a case where a coating layer is formed not only on one surface of a thin plate but also on both surfaces, or a case where a coating layer is coated by using a thin plate in the form of a coil to increase a production speed in continuous production, and include the case regardless of the presence or absence of additional processes, such as pressing, rolling, punching, and slitting after coating.

Also, the slurry is instead of being used as wet coated state, but is removed the solvent and then used.

In order to remove the solvent from a coating layer, one or more of vacuum drying, freeze drying, snap freezing, spray drying, air knife drying, air drying, oven drying, thermal decomposition by temperature increase, and so on may be used.

For example, it is possible to vaporize the solvent in an oven-drying or pyrolysis drying device as a basic method, and multiple drying methods may be used as necessary.

In another example, composite drying that promotes a removal speed of vaporized components may be performed by vacuum-drying with a vacuum pump while oven-drying.

Conventionally, by mainly considering only convection drying, hot air is supplied to lower and upper portions of a thin plate at the same time, and accordingly, isotropic drying is performed, and it is often difficult for a temperature gradient to be one-way.

In this case, there is a problem that a difference in drying speed between a surface and the center increases because the center of a thin plate is heated the latest.

In the isotropic drying, a surface is quickly dried by diffusion and convection, and accordingly, the volume of the surface region is reduced first.

On the other hand, in the center, a solvent evaporates as heat diffuses from a surface, but the concentration of the solvent decreases entirely due to diffusion.

However, in the isotropic drying method, the higher the temperature inside a drying device to increase a drying speed, and the higher the circulation speed of a drying fluid to promote convection, the greater the difference between the solvent evaporation rate on a surface of a coating layer and the solvent diffusion rate inside the coating layer, which causes cracks in the coating layer or peeling from a thin plate to easily occur on the surface of the coating layer.

When the temperature is lowered or the convection speed is lowered to prevent the cracks or peeling, the drying slows down, leading to uneven drying and poor quality due to spots in the coating layer.

The related art includes Korea Patent Publication No. 10-2015-0037242 (Apr. 8, 2015).

### SUMMARY

The present disclosure provides a thin-plate drying device for coating a thin plate with slurry, which may prevent a slurry coating layer to be defective by performing directional drying for a slurry coating layer according to a temperature gradient when coating a thin plate surface with slurry and drying the thin plate surface, reduce a turbulence of the solvent vapor, especially a micro-eddy, by supplying a drying fluid to the thin plate and slurry coating layer at different velocities and angles of θ°, and prevent a coating layer from peeling off by evenly drying the slurry coating layer.

Additional aspects will be set forth in part in the description which follows and, in part, will be apparent from the description, or may be learned by practice of the presented embodiments of the disclosure.

According to an aspect of the present disclosure, a thin-plate drying device for coating a thin plate with slurry includes a housing; a thin-plate support provided in an inner space of the housing and having an upper surface on which a thin plate including a slurry coating layer formed on a surface of the thin plate is mounted; and a heating unit provided below the thin-plate support and configured to heat a drying fluid in the inner space of the housing, wherein a temperature of a first drying fluid supplied to the thin plate by the heating unit is maintained to be relatively higher than a temperature of a second drying fluid supplied to the slurry coating layer.

In this case, the temperature of the first drying fluid supplied to the thin plate may be heated to have a temperature gradient of 10 to 150 °C with respect to the temperature of the second drying fluid supplied to the slurry coating layer.

In addition, the first drying fluid supplied to the thin plate and the second drying fluid supplied to the slurry coating layer may prevent turbulence from occurring due to speed differentiation.

Also, the housing may include an outlet provided on one side of the housing to discharge the first drying fluid and the second drying fluid in the inner space of the housing, supply holes formed on another side of the housing to supply the first drying fluid and the second drying fluid to the inner space of the housing through the supply hole, a first drying fluid blowing unit provided on a lower side of the thin-plate support among the supply holes of the housing to supply the first drying fluid supplied through the supply holes to the thin plate, a second drying fluid blowing unit provided on an upper side of the thin-plate support among the supply holes of the housing to supply the second drying fluid supplied through the supply holes to the slurry coating layer, and a circulation pipe having one side connected to the outlet and another side connected to the supply holes to circulate the first drying fluid and the second drying fluid discharged from the outlet to the supply holes.

In this case, the second drying fluid supplied to the slurry coating layer may be supplied at an angle of θ° with respect to a surface of the slurry coating layer.

Also, the first drying fluid supplied to the thin plate may be supplied at an angle of θ° with respect to the surface of the thin plate.

Here, the angle of θ° may be an angle of 0 to 45°.

In addition, the second drying fluid blowing unit may include a first perforated plate to supply the second drying fluid at the angle of θ°, or the first drying fluid blowing unit may include a second perforated plate to supply the first drying fluid at the angle of θ°.

In this case, each of the first perforated plate and the second perforated plate may have perforations formed at regular intervals along an area and extend guide pieces at an angle of θ° from the perforations, and the drying fluid discharged through the perforations may be supplied at an angle of θ° by the guide pieces.

In addition, the thin-plate drying device may further include a humidity adjustment unit provided on a side of the outlet of the housing to selectively condense a solvent included in the drying fluid discharged through the outlet to adjust humidity of the drying fluid which is relatively lowered and is circulated to the supply hole.

Also, the drying fluid may flow on a surface of the heating unit at an angle of θ° and flow in a laminar flow.

In this case, the heating unit may include a heat transfer fin provided on at least one of an inner side and an outer side of the heating unit to be in contact with the drying fluid.

Here, the heat transfer fin may have a spiral shape that is twisted about a flow direction of the drying fluid.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph illustrating movements of particles in a coating layer and a drying rate overtime during directional drying is made in a thin plate;

FIG. 2 is an example diagram illustrating micro-eddy (within dotted lines) that occur during a drying process of a coating layer;

FIG. 3 is an example diagram illustrating a thin-plate drying device for coating a thin plate with slurry, according to an embodiment of the present disclosure; and

FIGS. 4A to 4C example diagrams illustrating heating units of a thin-plate drying device for coating a thin plate with slurry, according to an embodiment of the present disclosure.

### DETAILED DESCRIPTION

Hereinafter, preferred embodiments according to the present disclosure will be described in detail with reference to the attached drawings. Prior to this, the terms or words used in the present specification and claims should not be interpreted as limited to their usual or dictionary meanings, and should be interpreted as meanings and concepts that conform to the technical idea of the present disclosure based on a principle that the inventor may appropriately define the concepts of the terms in order to describe his or her own invention in the best way.

Therefore, the embodiments described in the present specification and the configurations illustrated in the drawings are only the most preferred embodiments of the present disclosure, and do not represent all of the technical ideas of the present disclosure, and thus, it will be understood that there may be equivalent modification examples capable of being replaced at the time of filing the present disclosure.

The present disclosure relates to a thin-plate drying device for coating a thin plate with slurry, which may prevent a slurry coating layer to be defective by performing directional drying for a slurry coating layer according to a temperature gradient when coating a thin plate surface with slurry and drying the thin plate surface, reduce a turbulent flow of solvent vapor caused by a difference in local solvent vapor pressure on a surface of the slurry coating layer, especially a micro-eddy, by supplying a drying fluid to the thin plate and slurry coating layer at different velocities and angles of θ°, and prevent a coating layer from peeling off by evenly drying the slurry coating layer, and is described below with reference to the drawings.

First, a thin-plate drying device 100 according to an embodiment of the present disclosure performs directional drying by differentially heating drying fluids supplied to each of a thin plate 10 and a slurry coating layer 11 formed on a surface of the thin plate 10 to form a temperature gradient between the thin plate 10 and the slurry coating layer 11.

The directional drying achieves one-way directional drying by uniformly evaporating a solvent by convection while maintaining the temperature of the drying fluid on the thin plate 10 to be higher than the temperature of the drying fluid on the slurry coating layer 11.

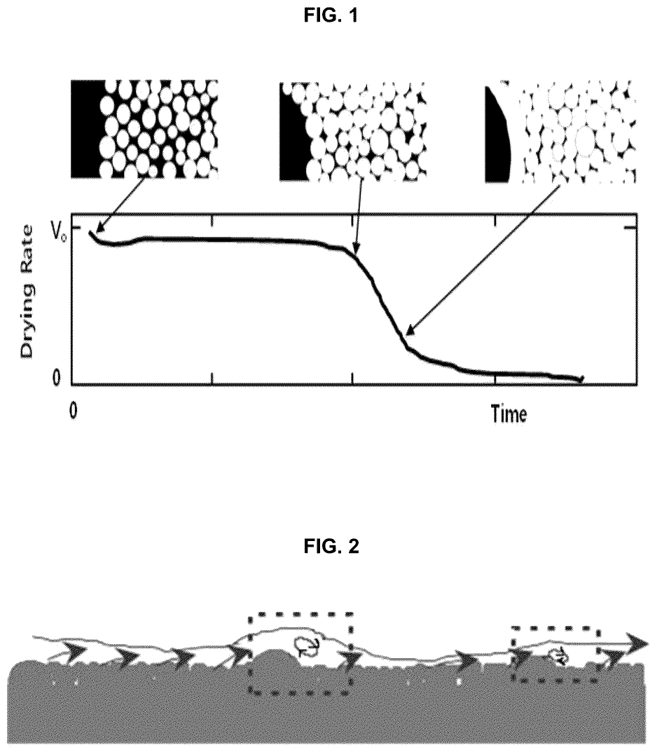

FIG. 1 is a graph illustrating movements of particles in a coating layer and a drying rate overtime during a directional drying process on a thin plate.

A solvent is in a void between the particles and moves through the void, and accordingly, the drying rate may be referred to as a solvent movement speed.

A phenomenon in which dew is condensed when heating the slurry coating layer 11 is likely to occur when the temperature of the thin plate 10, which is a substrate of the slurry coating layer 11, is lower than the temperature of the slurry coating layer 11.

By maintaining the temperature of the thin plate 10 to be higher than the temperature of the slurry coating layer 11 or to have a small difference, it is difficult for dew to be condensed on the slurry coating layer 11, and accordingly, moisture absorption decreases.

A major advantage of directional drying is that a passage is maintained such that the solvent may move and evaporate from a surface while drying is performed, and the vapor pressure of the solvent inside the slurry coating layer 11 decreases over time.

When the directional drying is performed, particles change into polygons due to diffusion caused by a concentration difference between the particles and particle growth, thereby forming grain boundaries and reducing voids between the particles, and drying is completed while the solvent concentration inside the slurry coating layer 11 decreases, and when the temperature is high enough to promote a reaction between the particles, the particles are combined with each other.

In the directional drying, spots, cracks, or peeling caused by uneven evaporation of the solvent may be easily reduced, and in particular, the consumption of organic solvents may be reduced.

In the directional drying, when evaporation of the solvent is faster than the movement and recrystallization of particles, the voids remain as pores in the slurry coating layer 11 and may be used as a passage for a liquid material injected in a subsequent process.

Here, a drying condition includes not only a drying condition of gradually increasing the temperature or gradually lowering the percentage relative humidity through each section in the drying device, but also a drying condition of increasing or lowering the drying temperature and increasing or lowering the percentage relative humidity for each section.

In other words, by applying a temperature gradient or concentration gradient, a temperature distribution between a thin plate and a slurry coating layer, and a drying speed difference between a surface and the inside of the slurry coating layer are reduced, and accordingly, cracks and peeling of the slurry coating layer in the thin plate may be reduced, and the quality is improved by making the drying speed uniform in directional drying.

To this end, drying may be performed by changing 1) at higher or lower temperature, 2) for longer or shorter time, 3) to lower or higher percentage relative humidity, for each section after an initial drying period.

When drying is performed while changing the relative humidity, a drying speed is adjusted by a difference between the vapor pressure of a surface of the slurry coating layer 11 and the atmospheric pressure inside the drying device while the solvent evaporates from the surface of the slurry coating layer 11 in the initial drying period.

That is, because the drying speed decreases as the relative humidity inside the drying device increases, the drying speed increases when the relative humidity is low in the initial drying period in the drying device, but while the temperature of the slurry coating layer 11 increases due to the increase in the drying temperature, the amount of solvent that evaporates increases, and accordingly, a movement speed of the solvent inside the slurry coating layer 11 also changes.

This is because a humidity change in the drying device is greater than a temperature change, and as the amount of thin plates 10 per unit volume increases, or the amount of thin plates 10 to be dried per unit time is increased to increase the drying speed, the amount of solvent to be evaporated increases, which lowers the temperature of a surface of the coating layer.

Therefore, even when the relative humidity in the drying device is uniform, when the amount of thin plates 10 to be dried is increased, the drying speed decreases.

In this case, in order to increase the drying speed, the drying temperature has to be increased even when the relative humidity increases in order to promote solvent evaporation in the slurry coating layer 11.

For this reason, an inversion phenomenon occurs where the drying speed increases even when the relative humidity is increased at a high temperature.

However, when the relative humidity exceeds a certain limit even at the high temperature, the drying speed decreases, and accordingly, the relative humidity is limited to 90% or less.

For example, when the relative humidity is less than 90% in an aqueous solvent, there are fewer water molecules around solid particles in the slurry, and thereby, hydrophilicity decreases due to the bonding between OH-groups, and the drying speed increases as the temperature increases.

However, when the relative humidity exceeds 90%, the hydrophilicity increases as the bonding between OH-groups is broken, and the drying speed decreases due to the tendency in which water molecules are bonded to each other.

As the solvent vaporizes during drying, the faster the drying speed is depending on the temperature and humidity of a drying fluid and a transport speed of the drying fluid, the greater the difference in local vapor pressure of the solvent on a surface of the slurry coating layer 11, and accordingly, local micro-eddies are formed.

During a slurry application process, the smaller and more spherical the particles are, the better the calendaring is, and accordingly, sizes of the micro-eddies are reduced, but it is not possible to apply the slurry such that the micro-eddy disappears completely.

Therefore, the speed at which the solvent vapor moves is reduced in a region where micro-eddies are formed within the dotted lines in FIG. 2, which causes a problem in that the drying speed changes, and the local difference in drying speed is the cause of uneven drying such as mura spot.

The drying fluid temperature changes depending on a slurry composition material, and in the present disclosure, an upper limit of the drying fluid temperature is preferably limited to 200 °C, which is the temperature required for vacuum drying or dissolving a polymer binder, and a lower limit of the drying fluid temperature is preferably limited to 25 °C, which is the lowest temperature at which the organic solvent may vaporize.

The percentage relative humidity is limited to a range of a maximum of 90% or less and a minimum of 30% or more to enable drying, and the drying time is set in a range of 1 minute to 40 hours sufficient to remove the solvent depending on a thickness of the slurry coating layer 11.

It is preferable to perform drying for 1 to 10 hours at the drying fluid temperature of 50 to 160 °C and a percentage relative humidity of 60 to 85%.

When the drying fluid temperature is less than 25 °C or the percentage relative humidity exceeds 90%, the drying time is excessively extended to reduce the productivity. when the drying fluid temperature is 200 °C or higher, cracks may occur in the slurry coating layer 11, separation of an interface between the slurry coating layer 11 and the thin plate 10, segregation due to rapid movement of a binder, capillary blockage due to reaction, oxidation of slurry components, and so on may occur. When the percentage relative humidity is less than 30%, cracks or segregation of binders may occur on a surface layer of the slurry coating layer 11 due to rapid solvent evaporation, so this is limited.

After drying is completed, the slurry coating layer 11 is loaded into a homogenization chamber and maintained for a certain period of time to achieve stabilization through diffusion of components, temperature uniformity, and so on in the slurry coating layer 11.

According to an embodiment of the present disclosure, the thin-plate drying device 100 performs directional drying to dry the slurry coating layer 11 formed (coated) on a surface of a thin plate 10 and to perform drying by differentiating the speed of a drying fluid supplied to the slurry coating layer 11 and the thin plate 10.

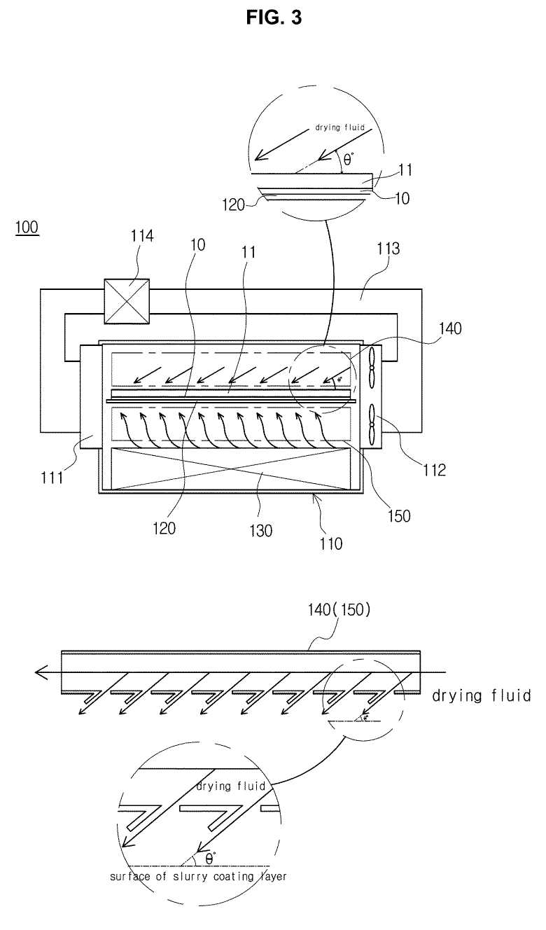

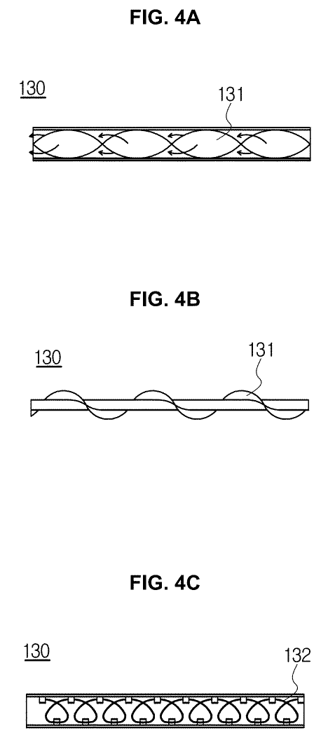

The thin-plate drying device 100 according to an embodiment of the present disclosure described with reference to FIGS. 3 and 4 includes a housing 110, a thin-plate support 120, a heating unit 130, a first drying fluid supply unit 140, and a second drying fluid supply unit 150. First, the housing 110 has an inlet formed on one side for introducing a drying material like a general drying device housing, an outlet formed on the other side for removing the drying material, and an inner space formed for receiving the drying material therein, and the inner space has an atmosphere (temperature, atmosphere pressure, and so on) for drying the received drying material.

In addition, the inner space of the housing 110 includes the thin-plate support 120 for supporting the thin plate 10 on which the slurry coating layer 11 is formed on a surface of the drying material.

In this case, it is preferable that the thin-plate support 120 is arranged to cause an area to be horizontal, and it is preferable that the thin-plate support 120 is composed of a perforated plate or a mesh plate such that the convection of a drying fluid is easily made in the inner space of the housing 110.

Here, the slurry coating layer 11 formed on a surface of the thin plate 10 is dried by evaporating the solvent included in the slurry coating layer 11 by a flow and convection of the drying fluid flowing along the surface, and the drying fluid may be warm air or nitrogen at a temperature higher than room temperature.

In general, at room temperature, the drying speed is increased when a drying fluid with a low relative humidity is used, but at a high temperature, the drying speed is increased when the drying fluid with a high relative humidity is used.

The reason is that, when the slurry coating layer 11 is heated to the corresponding temperature, moisture in the atmosphere gathers near the surface of the slurry coating layer 11, increasing the amount of water vapor, and the lower the temperature of the drying fluid, the more water vapor gathers in the slurry coating layer 11, increasing the amount of dew condensed on the slurry coating layer 11.

Therefore, in order to increase the temperature of a drying fluid, it is better to also increase the relative humidity, which may reduce the amount of atmospheric water vapor condensing on the slurry coating layer 11 during heating and increase a drying speed of the slurry coating layer 11.

For example, when the solvent is water, a cross-linking between hydroxyl groups is easily broken under high temperature and high humidity conditions, which increases the evaporation rate of a solvent.

Therefore, rather than ventilating and immediately removing a solvent that evaporates during drying, circulating a drying fluid to maintain a certain humidity increases a drying rate.

According to an embodiment of the present disclosure, an outlet 111 is formed on one side of the housing 110, a supply hole 112 is formed on the other side, the outlet 111 and the supply hole 112 are connected to a circulation path 113 through which a drying fluid flows, and accordingly, the drying fluid flowing out through the outlet 111 in the inner space of the housing 110 circulates back to the supply hole 112 along the circulation path 113.

Also, the outlet 111 according to an embodiment of the present disclosure may include a humidity adjustment unit 114, and the humidity adjustment unit 114 condenses a solvent included in the drying fluid discharged through the outlet 111 to adjust (adjust by using the amount of condensation) the relative humidity of the drying fluid supplied to the inner space of the housing 110.

For example, the humidity adjustment unit 114 is configured with a chiller, and the temperature of the drying fluid discharged through the outlet 111 is cooled to a constant temperature, thereby condensing the solvent included in the drying fluid, and the drying fluid passing through the humidity adjustment unit 114 is circulated back to the supply hole 112, and in this case, by adjusting the amount of condensation of the solvent, the relative humidity of the supply air (drying fluid) supplied to the inner space of the housing 110 may be adjusted.

Here, when the relative humidity of the slurry coating layer 11 is excessively low, cracks, binder segregation, or so on may occur on a surface of the slurry coating layer 11 due to rapid solvent evaporation.

In addition, when there is a large difference in drying speed between the surface of the slurry coating layer 11 and the inside thereof, cracks occur on the surface of the slurry coating layer 11.

When a surface temperature of the slurry coating layer 11 is excessively high and has a large difference from the inner temperature, the surface of the slurry coating layer 11 shrinks in volume due to solvent evaporation. As a result of the vaporized solvent, the pressure inside the slurry coating layer 11 increases, which causes the slurry coating layer 11 may be easily peeled away from the thin plate 10.

One of the most common and difficult problems encountered in drying the thin plate 10 having the slurry coating layer 11 formed on the surface is spot as known mura, which appear when the density of the slurry coating layer 11 is uneven and becomes more problematic as a production rate increases in fields such as lithium batteries for electric vehicles.

An organic solvent is used to increase the evaporation rate of a solvent, and the organic solvent includes a ketone such as acetone, tetrahydrofuran (TH F), or methyl ethyl ketone (ME K), a hydrocarbon such as benzene or toluene, an alcohol such as methanol or isopropanol (IPA), a halogenated alkanes such as ethylene dichloride (EDC) or propylene dichloride, an ester such as ethyl acetate or butyl acetate, ethylene carbonate (EC), fluoroethylene carbonate (FEC), propylene carbonate (PC), dimethyl carbonate (DMC), diethyl carbonate (DEC), ethyl methyl It includes methyl methyl carbonate (EMC), methyl propyl carbonate (MPC), gamma butyrolactone (GBL), enmethyl 2-pyrrolidone (NMP), diethylene glycol (DEG), dimethyl ether (DME), diglyme, or so on, and also includes an aqueous composition or an organic solvent mixed with the aqueous composition.

However, when a slurry composition including an organic solvent is applied in a layer form onto a thin plate 10 to increase an evaporation rate of the solvent, spots frequently occur.

Spots often occur in highly volatile organic solvents but also occur in aqueous slurry compositions including water as a main component, organic solvents with low volatility, or slurry compositions in which aqueous and organic solvents are mixed.

Also, the cause of spots occurring in the slurry coating layer 11 is mostly due to a physical disturbance of the solvent vapor on the surface of the slurry coating layer 11 during drying, which causes uneven drying due to the turbulent flow of a drying fluid.

Also, the inappropriate temperature gradient of the thin plate 10, uneven thermal diffusion, and uneven solvent vapor concentration of the drying fluid in the drying device cause an uneven evaporation rate in the slurry coating layer 11.

According to an embodiment of the present disclosure, the thin-plate drying device may condense and recover a solvent through the humidity adjustment unit 114, and the recovered and condensed solvent may be stored in a separate tank and sprayed to the drying fluid again from the supply hole 112 to adjust the relative humidity as needed.

Here, in order to increase the relative humidity of the drying fluid circulated through the supply hole 112, the solvent stored in a separate solvent tank may also be provided instead of using the condensed and recovered solvent.

Also, the pressure of the inner space of the housing 110 may be maintained at a negative pressure to prevent outer leakage of an organic solvent.

In addition, when the temperature of a surface where the solvent evaporates from the thin plate 10 decreases, the cooling due to the decrease of the surface causes a temperature difference in the slurry coating layer 11.

This temperature difference induces a convection flow in the atmosphere in contact with the surface of the slurry coating layer 11, and accordingly, when the evaporation of a solvent is uneven, the flow of a drying fluid in contact with the slurry coating layer 11 is disturbed, causing a turbulent flow on the surface of the slurry coating layer 11 and making the evaporation of the solvent more uneven.

The drying device 100 according to the embodiment of the present disclosure further includes a first drying fluid blowing unit 140 and a second drying fluid blowing unit 150, and accordingly, it is possible to achieve a directional drying by differentiation between a drying fluid speed of a first drying fluid flowing on a surface of the thin plate 10 and a drying fluid speed of a second drying fluid flowing on a surface of the slurry coating layer 11.

The first dry fluid blowing unit 140 is provided on a lower side of the thin-plate support 120 among the supply holes 112 of the housing 110 to supply the first dry fluid to the thin plate 10, and the second dry fluid blowing unit 150 is provided on a lower side of the thin-plate support 120 among the supply holes 112 of the housing 110 to supply the second dry fluid to the slurry coating layer 11.

The first dry fluid blowing unit 140 and the second dry fluid blowing unit 150 respectively induce the first dry fluid and the second dry fluid to flow at a constant speed while preventing the occurrence of a turbulent flow on the surfaces of the thin plate 10 and the slurry coating layer 11 in a one-way laminar flow.

Therefore, by individually adjusting (adjusting a rotation speed of a blower and so on) the first drying fluid blowing unit 140 and the second drying fluid blowing unit 150, a speed of the first drying fluid supplied to the thin plate 10 and a speed of the second drying fluid supplied to the slurry coating layer 11 may be differentiated from each other to achieve directional drying.

Also, the second drying fluid blowing unit 150 that supplies the second drying fluid to the slurry coating layer 11 may supply the second drying fluid at an angle of θ° with respect to the surface of the slurry coating layer 11.

In this case, the second drying fluid supplied to the surface of the slurry coating layer 11 may be supplied at an angle of θ° with respect to the surface of the slurry coating layer 11 by being induced by a nozzle or an air supply member to flow in a laminar flow.

The angle of θ° is an angle of 0 to 45°, and when the angle of θ° is less than 0°, it is difficult to install a device, and when the angle of θ° exceeds 45°, it may cause a turbulent flow by colliding with a coating layer, and accordingly, the angle at which the second drying fluid is supplied may also be limited to 40° or less, more preferably 30° or less.

Also, the second drying fluid blowing unit 150 may include a perforated plate 151 to supply the second drying fluid at an angle of θ°.

The perforated plate 151 forms perforations at regular intervals along an area and extends a guide piece 153 from a perforation 152 at an angle of θ°, and accordingly, the second drying fluid discharged through the perforation 152 may be supplied to the surface of the slurry coating layer 11 at an angle of θ° under the guidance of the guide piece 153.

In this case, the supply amount and flow rate of the second drying fluid may be adjusted by adjusting a perforation size, an interval, a shape, a perforation angle, and so on of the perforation plate 151, and accordingly, an evaporation rate of the solvent may be adjusted, and the heating temperature may be differentiated.

Also, the first drying fluid blowing unit 140 that supplies the first drying fluid to the thin plate 10 may also supply the first drying fluid at an angle of θ° with respect to the surface of the thin plate 10.

In addition, according to an embodiment of the present disclosure, the heating unit 130 is provided at the bottom of the thin-plate support 120 and heats the thin plate 10 placed on the thin-plate support 120.

The heating unit 130 may be selected from one or more of burner heating, electric resistance heating by a heating element, vacuum or low pressure heating, conductive Joule heating, electromagnetic heating, infrared heating, convection heating circulating high-temperature gas, and radiation heating using a tube circulating high-temperature gas.

Here, in the burner heating, air is supplied by a blower in general, and the drying fluid, which is heated by burning fuel, is supplied into the housing 110 of a drying device to perform drying.

In this case, in the present disclosure, a wire or a spiral fin is installed on an outer surface of a tube in the direction in which a drying fluid flows, and accordingly, the drying fluid rotates and moves along the spiral fin.

Alternatively, the Joule heating may circulate a drying fluid in a tube including a heating wire or a heating ceramic such as silicon carbide.

When the spiral fins are provided inside and outside the tube, it is preferable that the flow of a drying fluid moving along the spiral fins is induced as a laminar flow rather than a turbulent flow.

Therefore, the drying device 100 according to the embodiment of the present disclosure may maintain the heating temperature of the thin plate 10 to be higher than the heating temperature of the slurry coating layer 11 by the heating unit 130 located at a lower side of the thin-plate support 120 in an inner space of the housing 110, and a temperature gradient is formed by the differential heating of the slurry coating layer 11 and the thin plate 10 to achieve directional drying.

Here, the temperature of the thin plate 10 is heated to a temperature having a temperature gradient of 10 to 150 °C with the slurry coating layer 11, and preferably, the temperature is heated to a temperature having a temperature gradient of 50 to 100 °C, and accordingly, the temperature of a surface of the slurry coating layer 11 and the temperature of the thin plate 10 have temperature directivity.

Also, the heating unit 130 may be installed closely to the thin-plate support 120 for heating, and a nozzle or a supply hole through which a drying fluid flows may be installed at an angle of 0 to 45° on a surface of the heating unit 130 to promote heat.

Also, when inner and outer surfaces of the heating unit 130 are provided with unevenness or heat transfer fins 131, an area in contact with a drying fluid increases, and accordingly, the slurry coating layer 11 and the thin plate 10 may be uniformly heated.

For example, when the heat transfer fins are configured in a spiral shape in a direction in which a drying fluid moves as illustrated in FIG. 4, a contact area increases, a turbulent flow in the flow of the drying fluid is reduced, and a fluid flow close to a laminar flow is formed, which provides an effect of more uniform heating.

Also, a nichrome alloy wire 132 wound in a spiral shape at an angle of 10 to 45° may be installed inside a tube as the heating unit 130.

The nichrome alloy wire 132 including ceramic insulator bodies that block contact with the tube is inserted into a tube at regular intervals.

When a drying fluid moves inside the tube, the spiral nichrome alloy wire 132 induces the drying fluid to move laminarly inside the tube, and accordingly, uneven heating of the heating unit 130 may be reduced.

The following is an example of a thin-plate drying device according to an embodiment of the present disclosure.

### EXAMPLE

TABLE 1

| | | | | Relative | Fluid | Drying | | |
|---|---|---|---|---|---|---|---|---|
| | | Fluid 1 | Fluid 2 | humidity | velocity | time | | |
| No. | Solvent | (°C | (°C) | (%) | (m/min) | (min) | | Note |
| 1 | Distilled | 70 | 50 | 60 | 3 | 10 | minutes | Good |
| | water | | | | | | | |
| 2 | Distilled | 80 | 60 | 70 | 3 | 8 | min | Good |
| | water | | | | | | | |
| 3 | Distilled | 70 | 50 | 60 | 18 | 6 | min | Good |
| | water | | | | | | | |
| 4 | Distilled | 80 | 60 | 70 | 18 | 5 | min | Good |
| | water | | | | | | | |
| 5 | Distilled | 90 | 70 | 70 | 18 | 4.5 | minutes | Good |
| | water | | | | | | | |
| 6 | NMP | 110 | 90 | 70 | 3 | 4 | minutes | Good |
| 7 | NMP | 130 | 100 | 80 | 18 | 2.5 | minutes | Good |
| Comparative | Distilled | 60 | 60 | 60 | 3 | 24 | min | Slow |
| example 1 | water | | | | | | | drying |
| Comparative | Distilled | 70 | 70 | 70 | 18 | 7 | minutes | Crack |
| example 2 | water | | | | | | | |
| Comparative | NMP | 110 | 110 | 70 | 18 | 5 | minutes | Crack/ |
| example 3 | | | | | | | | Peeling |

As examples of drying a negative electrode material of the present disclosure which refers to Table 1, No. 1 to No. 5 and comparative example 1 and comparative example 2 are provided by adding acetylene black (Alfa Aesar) of 2.5 g which is a conductive agent and CMC-SBR (MTI Korea) of 2.5 g which is a binder, to natural graphite (MTI Korea) of 95 g, and a slurry is formed by mixing distilled water of 110 g, which is an aqueous solvent, therewith, and the slurry is applied with a coating width of 100 mm, a coating length of 100 mm, and an average thickness of 65 μm, and then dried under the condition below in a drying device having the structure of FIG. 3, and the drying time required to reach a coating layer thickness of about 31 μm is measured to relatively compare evaporation rates.

Also, as examples of drying a positive electrode material of the present disclosure, No. 6 and No. 7 and comparative example 3 are provided by adding acetylene black (Alfa Aesar) of 3 g which is a conductive agent and PVDF (Alfa Aesar) of 3 g which is a binder are added to NCM 955(Ronbay) of 94 g, and NMP of 67 g is mixed therewith as an organic solvent to form a slurry, and the slurry is applied with a coating width of 100 mm, a coating length of 100 mm, and an average thickness of 312 μm, and then, dried under the condition below, and the drying time required to reach a coating layer thickness of approximately 187 μm is measured to relatively compare evaporation rates.

As seen from this, a result of the directional drying example of the present disclosure is obtained as a fast and sound drying speed, whereas a result of the comparative example of the upper and lower isotropic drying shows an excessively slow drying speed or a part where a surface crack or peeling occurs.

Therefore, the thin-plate drying device according to the embodiment of the present disclosure may reduce a difference between a solvent evaporation rate on a surface of a slurry coating layer and a solvent diffusion rate inside the slurry coating layer by adjusting a flow rate of the directional drying or drying fluid.

Alternatively, one or more of the following may be selected and applied: adjusting the relative humidity by mixing a certain amount of the recovered solvent vapor with a drying fluid and injecting the mixture, adjusting a difference in circulation speed of the drying fluid, or adjusting a vapor condensation rate of a solvent and then discharging the solvent.

Therethrough, a difference between the vapor pressure (or an evaporation rate of solvent vapor in a coating layer) and the relative humidity in a drying device and a slurry coating layer may be adjusted according to a change in temperature of a drying fluid in the drying device.

When the solvent included in the slurry coating layer is water-based, a heating rate and the relative humidity may be adjusted by using high-temperature water vapor as the drying fluid or mixing air and water vapor.

In the directional drying of the present disclosure, the occurrence of a turbulent flow is reduced by maintaining a passage such that the solvent may diffuse in a coating layer and evaporate from a surface of the coating layer while drying is performed, and the directional drying has following advantages.

1) Even when the heating temperature is increased through the directional drying, cracks do not form in a slurry coating layer or peeling does not occur at an interface with a thin plate, and thus, a defect rate is reduced.

2) Because a solvent diffusion rate in a slurry coating layer is increased and a temperature difference is reduced and a defect rate is reduced, the drying time may be reduced, and a length of a drying device may be reduced to reduce a weight of a coated thin plate, and thus, the tensile force required for winding is reduced, which may solve the problem that the thin plate is deformed or broken in the drying device due to excessive tensile stress.

3) Cost may be reduced as a defect rate is reduced and productivity is improved.

4) By reducing a length of a drying device as much as a drying speed increases, the equipment is optimized, and equipment cost, space cost, labor cost, and management cost may be reduced.

5) The use of organic solvents may be reduced, and the organic solvents may be replaced with eco-friendly water-based solvents.

Also, the thin-plate drying device according to the present disclosure has following effects.

Even when the heating temperature is increased through the directional drying according to a temperature gradient between a thin plate and a slurry coating layer, cracks do not form in the slurry coating layer or peeling does not occur at an interface with the thin plate, and thus, there is an effect of reducing a defect rate.

Because a solvent diffusion rate in a slurry coating layer is increased and a temperature difference is reduced and a defect rate is reduced, there is an effect of reducing the drying time.

By reducing a length of a drying device, a weight of the coated thin plate is reduced to reduce the tensile force required for winding, and thus, it is possible to solve the problem that the thin plate is deformed or broken in the drying device due to excessive tensile stress.

Also, as described above, by reducing a defect rate and improving the productivity, cost may be reduced, and by reducing a length of a drying device as much as a drying speed increases, the equipment is optimized, and equipment cost, space cost, labor cost, and management cost may be reduced, the use of organic solvents may be reduced, and the organic solvents may be replaced with eco-friendly water-based solvents.

The present disclosure is described with reference to the embodiments illustrated in the drawings, but the embodiments are merely examples, and those skilled in the art will understand that various modifications and equivalent other embodiments may be derived therefrom. Therefore, the true technical protection scope of the present disclosure should be determined by the technical idea of the appended patent claims.

What is claimed is:

1. A thin-plate drying device including a thin plate having a surface coated with slurry and a slurry coating layer formed on the surface of the thin plate, the thin-plate drying device comprising:
a housing;
a thin-plate support provided in an inner space of the housing and having an upper surface on which a thin plate including a slurry coating layer formed on a surface of the thin plate is mounted; and
a heating unit provided below the thin-plate support and configured to heat a drying fluid in the inner space of the housing,
wherein a temperature of a first drying fluid supplied to the thin plate by the heating unit is maintained to be relatively higher than a temperature of a second drying fluid supplied to the slurry coating layer.

2. The thin-plate drying device of claim 1, wherein
the temperature of the first drying fluid supplied to the thin plate is heated to have a temperature gradient of 10 to 150 °C with respect to the temperature of the second drying fluid supplied to the slurry coating layer.

3. The thin-plate drying device of claim 1, wherein
the first drying fluid supplied to the thin plate and the second drying fluid supplied to the slurry coating layer prevent turbulence from occurring due to speed differentiation.

4. The thin-plate drying device of claim 3, wherein the housing comprises:
an outlet provided on one side of the housing to discharge the first drying fluid and the second drying fluid in the inner space of the housing;
supply holes formed on another side of the housing to supply the first drying fluid and the second drying fluid to the inner space of the housing through the supply hole;
a first drying fluid blowing unit provided on a lower side of the thin-plate support among the supply holes of the housing to supply the first drying fluid supplied through the supply holes to the thin plate;
a second drying fluid blowing unit provided on an upper side of the thin-plate support among the supply holes of the housing to supply the second drying fluid supplied through the supply holes to the slurry coating layer; and
a circulation pipe having one side connected to the outlet and another side connected to the supply holes to circulate the first drying fluid and the second drying fluid discharged from the outlet to the supply holes.

5. The thin-plate drying device of claim 4, wherein
the second drying fluid supplied to the slurry coating layer is supplied at an angle of θ° with respect to a surface of the slurry coating layer.

6. The thin-plate drying device of claim 5, wherein
the first drying fluid supplied to the thin plate is supplied at an angle of θ° with respect to the surface of the thin plate.

7. The thin-plate drying device of claim 6, wherein
the angle of θ° is an angle of 0 to 45°.

8. The thin-plate drying device of claim 7, wherein
the second drying fluid blowing unit includes a first perforated plate to supply the second drying fluid at the angle of θ°.

9. The thin-plate drying device of claim 8, wherein
the first drying fluid blowing unit includes a second perforated plate to supply the first drying fluid at the angle of θ°.

10. The thin-plate drying device of claim 9, wherein
each of the first perforated plate and the second perforated plate has perforations formed at regular intervals along an area and extends guide pieces at an angle of θ° from the perforations, and the drying fluid discharged through the perforations is supplied at an angle of θ° by the guide pieces.

11. The thin-plate drying device of claim 4, further comprising:
a humidity adjustment unit provided on a side of the outlet of the housing to selectively condense a solvent included in the drying fluid discharged through the outlet to adjust humidity of the drying fluid which is relatively lowered and is circulated to the supply hole.

12. The thin-plate drying device of claim 4, wherein
the drying fluid flows on a surface of the heating unit at an angle of θ° and flows in a laminar flow.

13. The thin-plate drying device of claim 12, wherein
the heating unit includes a heat transfer fin provided on at least one of an inner side and an outer side of the heating unit to be in contact with the drying fluid.

14. The thin-plate drying device of claim 13, wherein
the heat transfer fin has a spiral shape that is twisted about a flow direction of the drying fluid.
